(19) United States
(12) Patent Application Publication
(10) Pub. No.: US 2020/0410538 A1
(43) Pub. Date: Dec. 31, 2020

(54) USER'S PREFERENTIAL AD TARGETING

(71) Applicant: ACTV8, Inc., Beverly HIlls, CA (US)

(72) Inventor: Brian Shuster, Beverly Hills, CA (US)

(21) Appl. No.: 16/911,214

(22) Filed: Jun. 24, 2020

Related U.S. Application Data
(60) Provisional application No. 62/867,150, filed on Jun. 26, 2019.

(51) Int. Cl. G06Q 30/02

(52) U.S. Cl. CPC G06Q 30/0257; G06Q 30/0267; G06Q 30/0271

(57) ABSTRACT

A system and method to enable a user to receive targeted ad based on user pre-selected categories. An end-user application sends and receives data from a backend server, an ad server and a content server. The end user application extracts a device ID from the end user device and sends it to the backend server. After the end user application initiates a user session on the backend server, the end user application retrieves a list of pre-determined ad targeting categories. The end user application presents the end user with the list of pre-determined ad targeting categories for selection by the end user. After the user selects at least one of the ad targeting categories, the end user application sends each of the user selected ad targeting categories to the backend server for storage on the backend server for subsequent use by the ad server when sending ads to the user.

### FIELD OF THE INVENTION

The invention is directed to an ad targeting tool which enables consumers to pre-select categories and types of advertisements that they will receive when watching media, listening to audio, or seeing advertisements on web portals. The invention then dynamically serves those consumers personalized interactive, transactional ads, offers, and digital currency from any streaming or broadcast media to any device capable of receiving ads, playing video or audio media.

### BACKGROUND OF THE INVENTION

Currently, the targeting of ads uses decision making algorithms that infer viewer's/consumer's interest based on their browsing history. That is, web sites which are accessed by a viewer/consumer are input to an algorithm which seeks to present other web sites which contain information related in some way to an accessed web site. Although such algorithms can be very sophisticated, and provide reasonably accurate results, they of course are limited to the input provided to them which could include web sites visited by mistake or web sites visited for reasons other than actual interest by the viewer/consumer.

### SUMMARY OF THE INVENTION

The invention relates to how content distributors can provide consumers very personalized ads, offers, and coupons/digital currency, based on the consumer's pre-selected categories. By way of example, selected categories include fields such as fashion, technology, pets, entertainment, food, and beauty.

The invention operates to provide consumers/viewers (users) with audio and digital ads targeted to their specific preferences. The user preferences are selected and saved by consumers. With pre-selected categories based on taste, viewers and consumers alike receive ads that they are inclined to watch and are interested in. Tailored advertisements create further brand engagement and build a one-to-one relationship with the consumer. Once the consumer views the customized ad, the consumer is offered a coupon/digital currency that can be saved directly into their OEM wallet of choice.

For example, with a user preferential ad targeting solution, if a user is an avid golfer that has selected ads in his preferred categories, i.e., golf, views content, the user will be sent a targeted ad related to golf. Now that the user is provided with ads in favorite categories, the user is more likely to engage with the brand advertisements. The targeted offer can be bundled with additional content, offers, or coupons/digital currency that can be saved directly from the media the user is viewing into a mobile wallet.

### BRIEF DESCRIPTION OF THE DRAWINGS

FIG. 1 illustrates an overview of an opt-in method whereby each individual user has the ability to preselect the products and services of interest when presented with an advertisement.

FIG. 2 is a diagram showing the workflow of a system which allows users to select their preferred targeting categories from any device.

FIG. 3, is a diagram showing the workflow of a system using a back-end server to allow an administrator to create a set of predefined categories to be retrieved by end-users.

### DETAILED DESCRIPTION OF THE INVENTION

As a preliminary matter, it will readily be understood by one having ordinary skill in the relevant art that the present disclosure has broad utility and application. Therefore, any embodiment may incorporate only one or a plurality of the disclosed aspects of the disclosure and may further incorporate only one or a plurality of the disclosed features. Furthermore, any embodiment discussed and identified as being “preferred” is considered to be a particular mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof.

Thus, for example, any sequence(s) and/or temporal order of steps of various processes or methods that are described herein are illustrative and not restrictive.

Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claims rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Advertising as presented today is focused on the inferring of user preferences based on user browsing history. A commercial on TV or radio or any broadcast medium is delivered to the consumer/viewer/listener with the only connection being that the user happens to be watching a particular piece of content at the time the ad is delivered. This invention works in a reverse mode in that the invention is based on an algorithm that uses a set of user's preselected set of categories to make decisions on how to target the delivery of advertisements.

Currently, when a consumer is watching media or listening to audio, on a media-playing device, T.V., laptop, or mobile device, the consumer sees or hears an advertisement based on a choice made by a programmatic computer or by a media programmer. With the invention, the viewer or listener will see or hear ads based on items, brands, or categories they have preselected. This invention replaces current video and audio ad serving technologies that have no direct input from the viewer or listener.

The invention uses decoding algorithms to extract unique identifiers that have been embedded into audio, video, geofences, Bluetooth beacons and printed media (for example QR Codes). The specifics of such algorithms are well known in the art. However, when an app running on a mobile device detects the signal embedded in the mentioned media, it triggers the further processing described below.

To enable targeted triggers, consumers can opt-in to receive targeted offers upon registration with a provided web site or equivalent. Alternatively, existing users are prompted to select their favorite categories via app upgrade notifications and/or reminders. After opting in to receive targeted offers and coupons, a product/offer/coupon/digital currency based on the video or audio ad being served is delivered to the consumer's mobile device. The user watching the commercial can then save this offer directly to a native OEM wallet app such as Apple® Wallet, Google® Pay, or the like.

The invention provides a unique experience in that video and audio ads are now targeted based on the consumer's preselected preferences, capitalizing on viewers' taste for personalized experiences. The invented solution enhances targeting capabilities by enabling consumers to preselect the categories they wish to see presented in advertisements.

The invented digital ad concept allows the user to receive a relevant ad based on the viewer's preselected and preferred categories. More specifically, a method is provided for delivering preselected targeted advertising information during a static, video, or audio commercial on a mobile device from the T.V., laptop, or mobile device. When a consumer watches or listens to an advertisement via any screen or device, after opting in to receive targeted offers, their device prompts them with a button for a product/offer/coupon/digital currency to be saved into a digital wallet.

For example, as a new subscriber to a video streaming platform, as the subscriber/user creates an account for the streaming platform, the user is prompted to select categories (e.g., fashion, technology, pets, entertainment, food, beauty) from which the user wish to be served ads. After selecting categories, while watching or listening to the user's content of choice, the user is then served tailored advertisements and products, and given an opportunity to act in real time.

Additionally, the streaming platform can choose the percentage of tailored ads delivered. Although the user may then be exposed to products for which there is no interest, new brands can still be presented to reach all consumers. Of course, the percentage of such untailored ads could be used as part of the pricing mechanism for the streaming platform.

By way of example, a user decides to watch content from a video broadcaster/streamer from their T.V., laptop, or mobile device. The user opts-in and pre-selects preferred categories of advertisements that are of interest to the user. During the viewing experience, when the consumer is served an ad, it will be from a pool of products or services pre-selected by the viewer or consumer. Those interactive, transactional ads can be strategically served across all screens based on the consumer's selected preferences.

In this manner, the ability to enable any device (i.e., T.V. laptops, or mobile device) to serve an advertisement and an associated offer specifically related to the pre-selected categories that the user/viewer had chosen is provided.

As a further example, a user is listening to a podcast from any podcast/broadcaster/streaming platform from a radio, laptop or mobile device. The user opts-in and pre-selects preferred categories of advertisements that are of interest to the user. During the listening experience, when the user is served an ad, it is from a pool of products or services pre-selected by the listener. Those interactive, transactional ads can be strategically served from the device playing the content to any screen based on the user's selected preferences, allowing brands to dynamically serve interactive, transactional ads across all screens to connect to their prime audience based on user presences. With one click, the user can save a coupon/offer/product/currency provided during the ad to a native OEM wallet app.

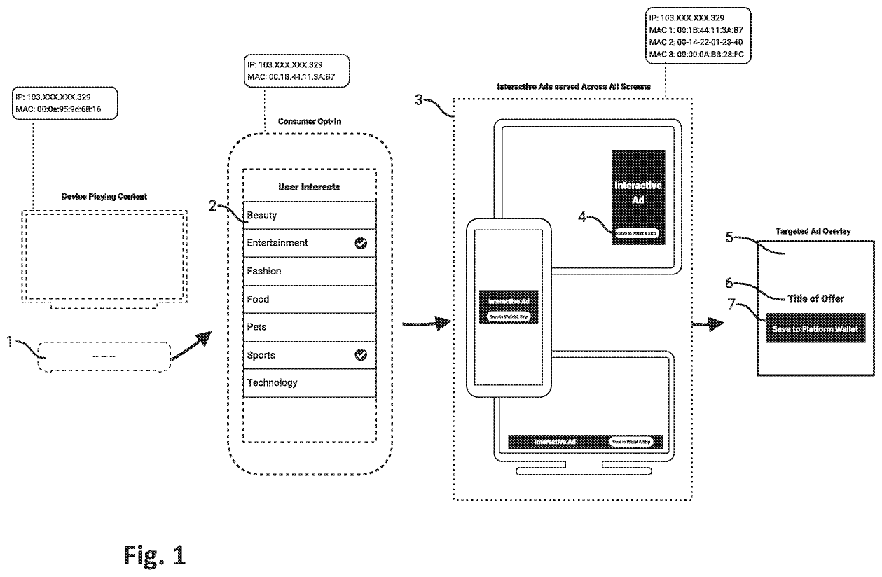

FIG. 1 illustrates an opt-in method whereby each individual user has the ability to preselect the products and services of interest in learning more so as to capitalize on the user's taste for personalized experiences. Allowing brands to dynamically serve interactive, transactional ads across all screens enables brand owners to connect to their prime audience based on consumer preferences.

The content is playing from any device 1 (TV, laptop or mobile device represented in dashed lines). A second device 2, typically a mobile device, includes an app allowing the device to unlock the “user's preferential” targeting capabilities by presenting a display 2 from which the user opts-in and selects preferred categories such as fashion, technology, pets, entertainment, food, beauty that resonate with their demographic and lifestyle via the mobile app.

Interactive ads 3 are strategically served based on the user's selected preferences across all devices 1 playing content (TV, laptop or mobile device). These devices are identified to an ad server (described below) through a backend server (described below) via a MAC address as follows. The backend server collects the MAC address of all devices which share an IP address, that is, are on the same network. In this manner, a served ad is sent to all devices on the network. As a result, if a user is watching content on a TV, and an ad is going to be played, the ad would also be sent to a laptop or mobile device on the network, which devices may have better interactive capabilities than a TV.

A Save to Wallet & Skip button 4 is displayed for specified ad media (the wording within the button is dynamic and can be custom) at which time the ad display area 5 changes to a neutral background. A product/offer/coupon/digital currency title 6 related to the interactive ad 3 is displayed to enable the user to recall the product/offer/coupon/digital currency which was just served, and then be delivered to a native OEM wallet 7 if desired.

The specifics regarding the Save to Wallet & Skip button 4, the product/offer/coupon/digital currency title 6 and the native OEM wallet 7 are not critical to an understanding of the invention.

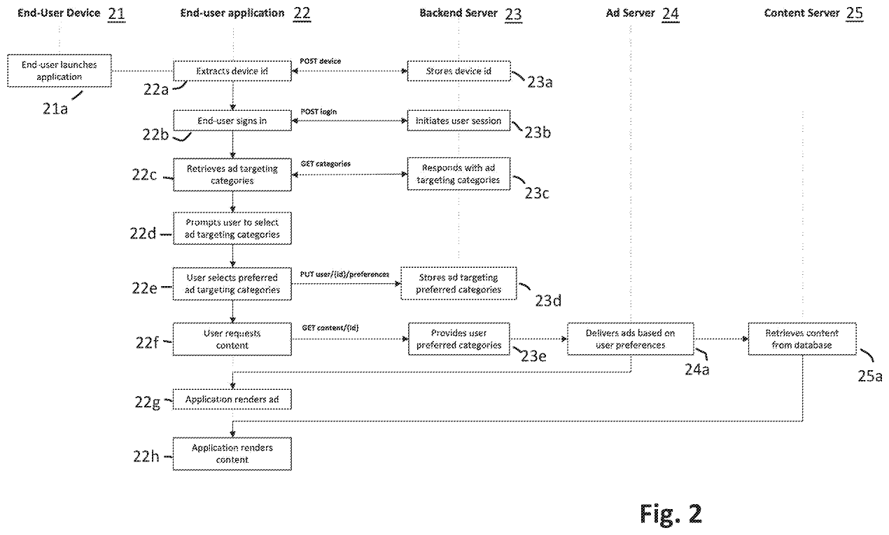

FIG. 2 is a diagram showing the workflow of a system which allows users to select their preferred targeting categories from any device.

As shown in FIG. 2, there are five main elements to the system, end user device 21, end user application 22, backend server 23, ad server 24 and content server 25. End user device 21 is an existing device such as a smart TV or a mobile phone. End user application is an app the user has downloaded to device 21. Backend server 23 is a server which is accessed by the app. Ad server 24 is a prior art server configured to accept data from backend server 23 relating to preferred categories selected by the user. Content server 25 is a prior art server which presents content to be viewed by the user when content is sent for display on device 21.

Upon end user application 22 request, the back-end server responds with the corresponding categories to be presented to end-users for further selection. Based on end-user preferences, end-users select the categories that most interest them and these are stored by the back-end server to be used as part of the targeting factors during ad serving.

The user experience is based on the assumption that the end-user initiates a request to stream content from a streaming content provider via end user application 22. Content server 25 refers to a server used to serve content provided by a streaming service. During the streaming of content, the end user application makes a request to ad server 24 to deliver advertisements. In this manner, a user's preferred categories which are preselected are used by the ad server in determining what advertisements are to be played.

The end user launches 21a an end user application or app 22 which runs on end user device 21. A device ID is extracted 22a from each device where content and ads are to be displayed. The device ID is typically a MAC address as shown in FIG. 1 where each device on which an as to be served has its own MAC address and is stored 23a on backend server 23.

Then, in order for the user to select and targeting categories, the end-user signs in 22b and initiates a user session 23b with backend server 23. Once the user session has been initiated, backend server 20 provides ad targeting categories 23c to end-user application 22 which retrieves 22c the ad targeting categories which are then displayed on end-user device 21 for the user to select.

After being prompted to make selections, the user selects 22e preferred ad targeting categories which are then stored 23d on backend server 23.

The foregoing steps are performed one time, or whenever the user desires to change selected preferred ad targeting categories.

Once the categories have been selected, the user requests content 22f, sending the request to backend server 23 which provides the user preferred 22e categories to add server 24. Ad server 24 then delivers 24a ads based on the user preferences. Content server 25 contains programming with media content which is retrieved 25a from a content database and sent to end-user application 22 which renders 22h the provided content.

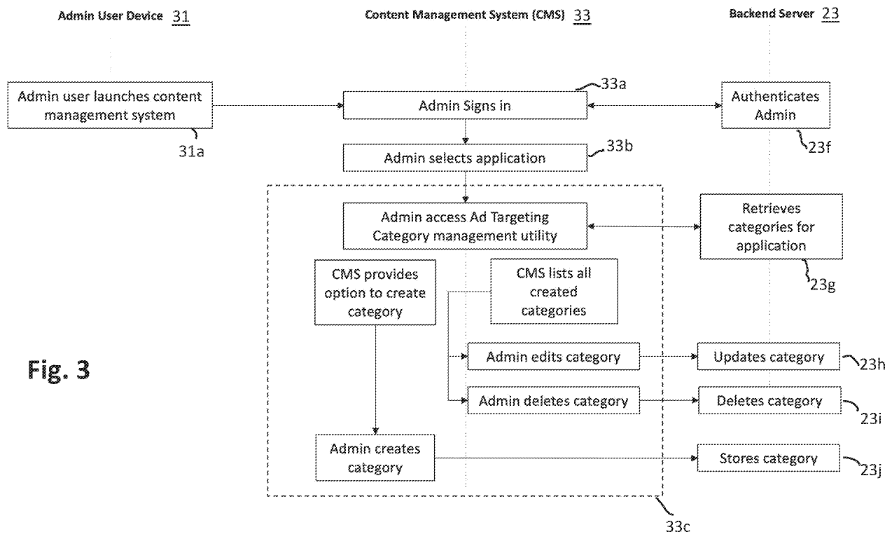

As shown in FIG. 3, the back-end server 23 allows an administrator to create a set of predefined categories to be retrieved by end-users via the end user application using an admin user device 31 and content management system (CMS) 33.

The admin user device 31 which may be a desktop or laptop computer, or a mobile device is used to launch CMS 33. After the admin user signs in 33a to the CMS and selects 33b an application, which is an ad targeting management utility, which is a component of a database update system 33c. The ad targeting management utility accesses backend server 23 to retrieve 23g categories currently stored on the backend server. The database update system then operates so that the CMS lists all of the retrieved categories. The admin user can the edit or delete a category which the CMS communicates with the backend server to update 23h the category or delete 23j the category. The CMS also allows the admin user to create new categories which are then stored 23j on the backend server. CMS systems are well known in the art and therefore need not be further defined.

Generally, consistent with embodiments of the disclosure, aspects of the invention may be implemented as program modules which include routines, programs, components, data structures, and other types of structures that may perform particular tasks or that may implement particular abstract data types. Moreover, embodiments of the disclosure may be practiced with various computer system configurations, including computer servers, hand-held devices, general purpose graphics processor-based systems, multiprocessor systems, microprocessor-based or programmable consumer electronics, application specific integrated circuit-based electronics, minicomputers, desktop, laptop mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, or device. The computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory such as RAM or ROM and other storage mediums, data can also be stored on or read from other types of computer-readable media, such as secondary storage devices, like hard disks, solid state storage (e.g., USB drive), or a CD-ROM, a carrier wave from the Internet. Further, the disclosed method stages may be modified in any manner, including by reordering stages and/or inserting or deleting stages, without departing from the disclosure. Although the invention has been explained in relation to its preferred embodiment, it is to be understood that many other possible modifications and variations can be made without departing from the spirit and scope of the invention as defined by the following claims.

I claim:

1. A system to enable a user to receive targeted ad based on user pre-selected categories comprising:
an end-user application for installation on an end user device by said user, said end user application for sending and receiving data from a backend server, an ad server and a content server;
wherein,
said end user application extracts a device ID from said end user device and sends said device ID to said backend server for storage on said backend server;
said end user application initiates a user session on said backend server;
after said user session initiation, said end user application retrieves a list of pre-determined ad targeting categories from said back end server;
said end user application via said end user device presents said end user with said list of pre-determined ad targeting categories for selection by said end user using said end user device;
after said user selects at least one of said ad targeting categories, said end user application sends each of said user selected ad targeting categories to said backend server for storage on said backend server.

2. The system defined by claim 1 further comprising upon request by said user, said end user application communicating with said back end server to obtain user requested content stored on said content server and ads stored on said as server, said backend server for communicating with said ad server to provide said user selected ad categories to said ad server, and with said content server to provide said user requested content.

3. The system defined by claim 2 wherein said end user application receives from said ad server ads based on said user selected ad categories and receives from said content server content based on said user requested content.

4. The system defined by claim 3 wherein said end user application renders on said end user device said ads based on said user selected ad categories and said content based on said user requested content.

5. A system to enable a user to receive targeted ad based on user pre-selected categories comprising:
a back end server configured to receive data from an end-user application installed on an end user device by said user, an ad server and a content server;
wherein,
said backend server receives from said end user application a device ID extracted by said end user application from said end user device and stores said device ID on said backend server;
said backend server initiates a user session on said backend server upon request from said user application;
after said user session initiation, said back end server receives a request for a list of pre-determined ad targeting categories from said end user application and sends said list to said end user application for presentation by said end user application via said end user device to said end user for selection by said end user using said end user device;
after said user selects at least one of said ad targeting categories, said backend server receives from said end user application each of said user selected ad targeting categories, and stores each of said user selected ad targeting categories on said backend server.

6. The system defined by claim 5 wherein said backend server upon receiving a request by said user from said end user application for content stored on said content server, said backend server communicates with said ad server to provide said user selected ad categories to said ad server, and with said content server to provide said user requested content to said end user application.

7. The system defined by claim 6 wherein said end user application is for receiving from said ad server ads based on said user selected ad categories and is for receiving from said content server content based on said user requested content.

8. The system defined by claim 7 wherein said end user application is for rendering on said end user device said ads based on said user selected ad categories and said content based on said user requested content.

9. A method to enable a user to receive targeted ad based on user pre-selected categories wherein after installing an end-user application on an end user device by said user, said end user application for sending and receiving data from a backend server, an ad server and a content server, said method comprises:
said end user application extracting a device ID from said end user device and sending said device ID to said backend server for storage on said backend server;
said end user application initiating a user session on said backend server;
after said user session initiation, said end user application retrieving a list of pre-determined ad targeting categories from said back end server;
said end user application via said end user device presenting said end user with said list of pre-determined ad targeting categories for selection by said end user using said end user device;
after said user selects at least one of said ad targeting categories, said end user application sending each of said user selected ad targeting categories to said backend server for storage on said backend server.

10. The method defined by claim 9 further comprising upon request by said user, communicating with said back end server to obtain user requested content stored on said content server and ads stored on said as server, said backend server for communicating with said ad server to provide said user selected ad categories to said ad server, and with said content server to provide said user requested content.

11. The method defined by claim 10 further comprising receiving from said ad server ads based on said user selected ad categories and receiving from said content server content based on said user requested content.

12. The method defined by claim 11 wherein said end user application renders on said end user device said ads based on said user selected ad categories and said content based on said user requested content.

13. A system for adding, deleting and updating categories to enable a user to receive targeted ads based on user pre-selected categories comprising:
a backend server configured to authenticate an administrative user and communicate with a content management system;
wherein said backend server retrieves from said content management system a list of said categories to be added to, deleted from and updated;
wherein said content management system is configured to list all created categories and enable said user to create new categories, edit said categories, and to provide to said backend server said created and edited categories for storage by said backend server, and to provide said backend server with instructions to delete categories stored on said backend server.
